(19) United States
(12) Patent Application Publication
(10) Pub. No.: US 2010/0043240 A1
(43) Pub. Date: Feb. 25, 2010

(54) Melon Cutting Tool And Method

(76) Inventor: Robert Kevork Balian, Alpharetta, GA (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(21) Appl. No.: 12/194,443

(22) Filed: Aug. 19, 2008

(51) Int. Cl. B26B 25/00

(52) U.S. Cl. 30/307; 83/13

(57) ABSTRACT

A tool to cut edible portions of a melon in which a pair of blades attach to a handle in spaced-apart relation, a cutting plate connects between opposing second ends of the blades, and a guide member rotatably attaches to the cutting plate, the guide member traveling on a rind surface when the tool is moved through the melon from one side to the other so that the blades and the cutting plate cut edible portions from the rind. A method of cutting edible portions of a fruit is disclosed.

### TECHNICAL FIELD

The present invention relates to tools and methods for cutting edible portions of fruits from rinds. More particularly, the present invention relates to a cutting tool having a rotatable guider that travels on a rind surface to guide the operation of the tool for separating edible portions of melons from the rind.

### BACKGROUND OF THE INVENTION

In recent years, increased attention has been directed to the dietary requirements of individuals for purposes of improving health and longevity. The consumption of certain food products including fruits and vegetables is encouraged, and particularly encouraged is the consumption of fresh or uncooked fruits and vegetables. These food products include a wide range of vitamins and minerals that are useful for healthful living, as well as various fluids and fibers that contribute to well being.

Generally, fruits and vegetables have an edible portion enclosed within a skin or rind. It is appreciated that for some fruits and vegetables, the enclosing skin or rind is edible while in others, the rind is considered not generally edible. For example, apples have a skin that is edible while bananas and melons have rinds that are generally not edible.

Preparation for consumption of fruits and vegetables having rinds or skins which are not edible involves opening the fruit and removing the edible portions. This generally is accomplished by cutting the fruit open, for example, cutting into halves or quarters. The edible portion attached to the rind is then removed. Various devices have been developed for removing edible portions of fruits from rinds. A knife having a handle and blade often is used to cut the opened melons or other fruits, and to separate the edible portion from the rind for removal. The knife must be handled carefully first to cut a section of the opened fruit and second to separate the edible portion from the rind to which it is attached. In addition, specialized tools, such as cupped spoons, are used to separate edible portions while providing an ornamentally attractive spherical melon portion for consumption, for example, for a fruit salad.

While knives and cutting spoons have been useful in cutting edible portions of melons from rinds, there are drawbacks to their use. The spoons generally leave pockets or residual portions of the fruit in the melon portion. Thus the fruit is not fully utilized, but such residual is acceptable for providing an ornamentally attractive fruit salad. The use of the knife however requires handling both the knife and portions of the melon. Juices make the handling difficult and sticky. This requires cleanup, and washing and drying of hands during the process of removing the edible portions. Such messy preparation is not desirable.

Accordingly, there is a need in the art for a cutting tool and method to separate edible portions of a fruit from the rind for removal. It is to such that the present invention is directed.

### SUMMARY OF THE INVENTION

The present invention meets the need in the art by providing a cutting tool operated to separate edible portions of a fruit, in which the tool includes a handle having a pair of blades disposed in spaced-apart parallel relation to define a gap therebetween and attached at respective first ends to the handle, each of the blades having at least a first cutting edge in opposing relation. A cutting plate connects between opposing second ends of the pair of blades. At least one guide member rotatably attaches to the cutting plate, which guide member rotates in response to guidingly bearing on a rind surface of the melon while the tool is moved from a first side edge of the melon to an opposing second side edge, the blades cutting edible portions of the melon and the cutting plate cutting the portion from the rind.

In another aspect, the present invention provides a method of cutting edible portions of a melon, comprising the steps of:

(a) positioning a guide member of a cutting tool on a boundary of the melon between a rind and an edible portion of the melon, the guide member rotatably attached to a cutting plate connected between end portions of a pair of spaced-apart blades attached at opposing ends to a handle, the blades defining a gap therebetween, each of the blades having at least a first cutting edge;

(b) moving the tool at an oblique angle in a first direction to drive the guide member along the boundary and the blades into and through the edible portion of the melon to a second opposing side of the melon, the cutting plate separating the edible portion along the boundary with the rind; and

(c) moving the tool in second direction with the guide member rotating along the boundary to remove the tool from within the melon outwardly thereof and leaving a readily removable severed edible portion of the melon.

Objects, advantages, and features of the present invention will become readily apparent upon reading the following detailed description in conjunction with the drawings and the appended claims.

### BRIEF DESCRIPTION OF THE DRAWINGS

FIG. 1 illustrates in perspective view a first embodiment of a cutting tool according to the present invention.

FIG. 2 illustrates a side view of the cutting tool shown in FIG. 1.

FIG. 3 illustrates a second side view of the cutting tool shown in FIG. 1.

FIG. 4 illustrates a second embodiment of a cutting tool according to the present invention.

FIG. 5 illustrates in cross-sectional view the cutting tool in operation of cutting edible portions of a melon from a rind of the melon.

FIG. 6 illustrates a top plan view of cutting pattern for cutting edible portions from a melon.

### DETAILED DESCRIPTION

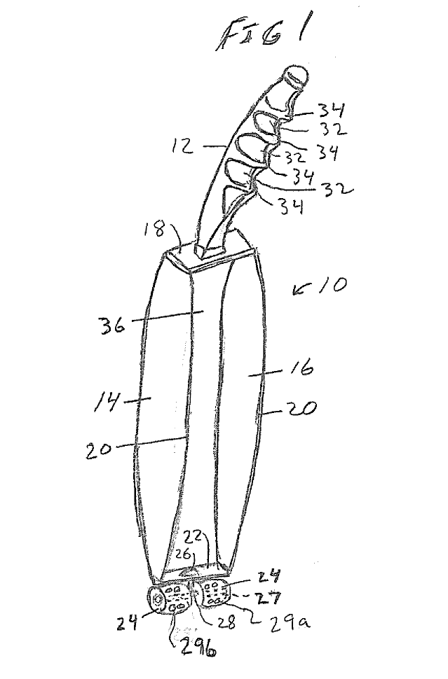

With reference to the drawings, in which like parts have like reference numerals, FIG. 1 illustrates in perspective view a first embodiment of a cutting tool 10 according to the present invention. The cutting tool 10 includes a handle 12 to which a pair of cutting blades 14, 16 attach. In the illustrated embodiment, the handle 12 includes a bridge 18 attached at a first end. The cutting blades 14, 16 attach to opposing edges of the bridge 18. Each cutting blade 14, 16 has at least a first cutting edge 20 in opposing relation relative to the adjacent cutting blade. The cutting edge 20 may be serrated (not illustrated), but a taperingly pointed cutting edge is satisfactory. A cutting plate 22 connects between opposing second ends of the blades 14, 16. At least one guide member 24 rotatably attaches to the cutting plate 22. In the illustrated embodiment, a support member 26 extends from the cutting plate 22 and connects to an axle 28. At least one guide member 24 receives the axle 28 for rotation. In the illustrated embodiment, a pair of guide members 24 attach to the axle. The axle 28 extends through an axial bore 27 of the guide member 24. A cap or stop member 25 secures the guide member 24 to the axle 28. In an embodiment with one guide member, opposing support plates extend from the cutting plate 22 to engage and support the axle on which the guide member 24 rotates. Other rotatable connections and supports can be gainfully employed within the context of the structure of the present invention.

The guide member 24 may be cylindrical, or as shown in the illustrated embodiment, the guide member is barrel-shaped having an arcuate surface radially spaced from the axle bore. Further, the surface of the guide member 24 in alternate embodiments is textured for traction, such as with a plurality of alternating ridges and grooves, holes, dimples 29a, projections 29b, or other surface engaging features, to facilitate rotation of the guide member across a rind surface as discussed below.

In the illustrated embodiment, the handle 12 attaches at an oblique angle relative to the bridge 18. The handle 12 may be linear or curvilinear for comfortable gripping. Further, the handle 12 in the illustrated embodiment includes a plurality of spaced-apart recesses 32 and ridges 34 in an undersurface and side surfaces. The recesses and ridges provide a comfortable grip for the fingers of a user operating the cutting tool 10. The handle 12 can further include a finger guard and return. The finger guard in one embodiment provides a skirt or plate (not illustrated) that extends outwardly around the perimeter of the bridge 18.

The handle 12 may be manufactured from a resilient material, include a cushion, or may be rigid, such as of wood, plastic, metal or other suitable material for a grip. The handle 12 may be an integral molded member or comprise opposing shells that matingly join and are secured together with fasteners such as glue, rivets, or other connecting members. The cutting blades may be metal, plastic, or other suitable material for a cutting device. In an alternate embodiment, the cutting blades 14, 16, the bridge 18, and the cutting plate 22 are formed as an integral plastic molded piece.

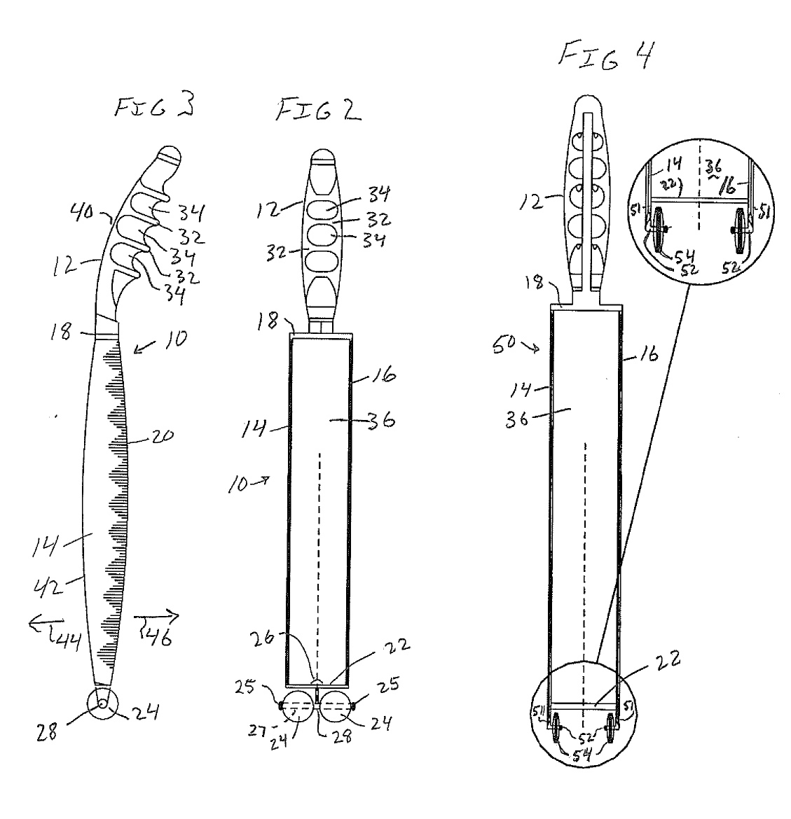

FIG. 2 illustrates the cutting tool 10 shown in FIG. 1 in side view. The spaced-apart blades 14, 16 define a gap 36 that extends between the bridge 18 and the cutting plate 22. As discussed below, the gap 36 receives portions of the edible portion of the melon during the cutting process.

FIG. 3 illustrates a second side view of the cutting tool 10 to show a curved surface 40 of the handle 12 opposing the recesses 32 and ridges 34 of the handle. The cutting edge 20 defines an arcuate shape between the bridge 18 and the cutting plate 22. The edge 20 however may be straight. An opposing edge 42 is similarly curved or straight. The opposing edge 42 can also define an opposing cutting edge. In that way, the cutting tool 10 can be moved cuttingly in a first direction as indicated by the arrow 44 or in the opposite direction indicated by the arrow 46.

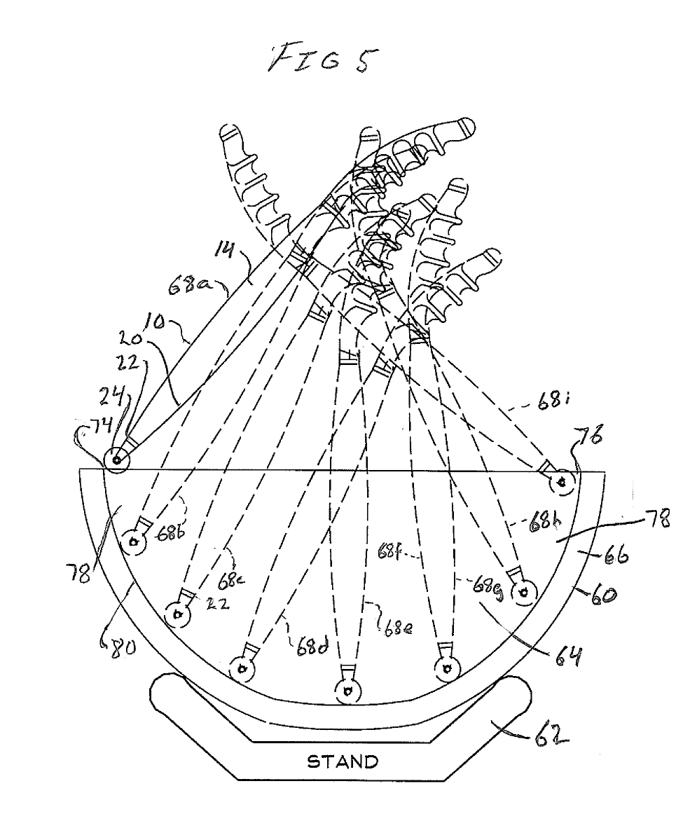

FIG. 4 illustrates in side view a second embodiment of a cutting tool 50 according to the present invention with a detailed illustration of a portion of the tool showing the guide member. The cutting tool 50 includes the handle 12 and the pair of cutting blades 14, 16 connected to the bridge 18 and the cutting plate 22. The blades attach to the bridge and the cutting plate by welding, sonic attachment, rivets (not illustrated), or other conventional manner for the particular materials involved in the structure. In this second embodiment, distal portions 51 of the cutting blades 14, 16 extend past the cutting plate 22. A lug 52 projects from the distal end of each cutting blade 14, 16 towards the opposing cutting blade. A disc-shaped roller 54 rotatably attaches to the respective lug 52. The roller is secured, such as with a rivet, a cap attached to the lug 52, or other securing device.

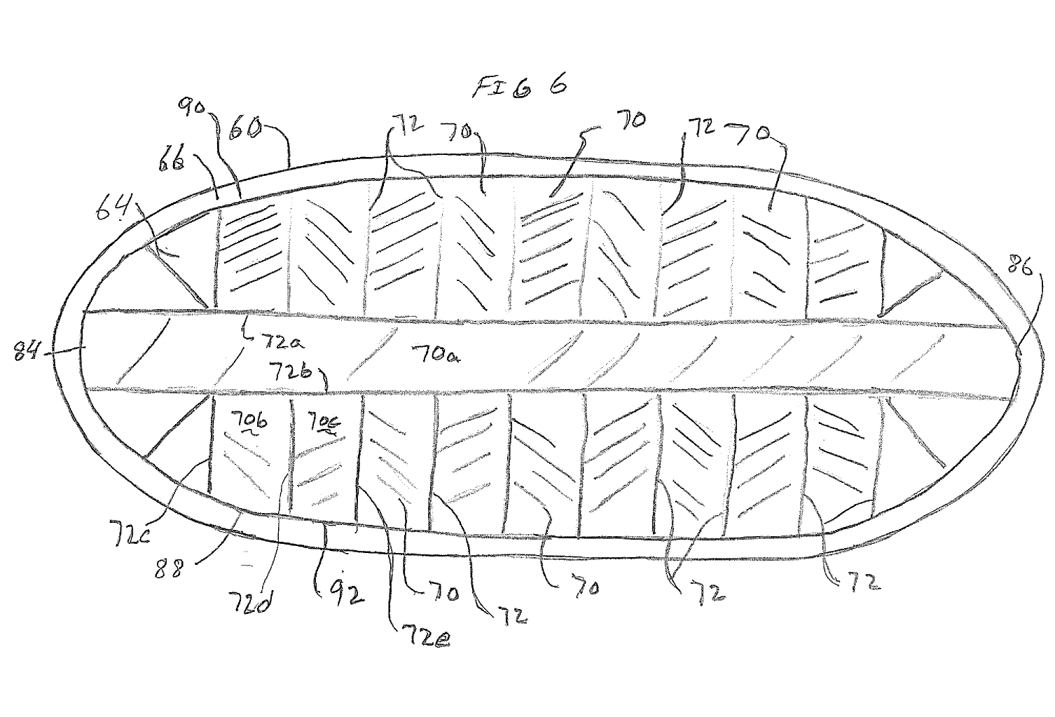

FIG. 5 illustrates in cross-sectional view a cut portion of a melon 60 supported in a stand 62. The melon 60 includes an edible portion 64 attached to a rind 66. The stand 62 is generally U-shaped in cross-sectional view and provides opposing lateral support for the melon during the cutting process. FIG. 5 further illustrates a plurality of sequential positions 68a-68i of the cutting tool 10 while using the cutting tool to cut edible portions of the melon 60 from the rind 66.

FIG. 6 illustrates a top plan view of a cutting pattern for cutting sections 70 of the edible portion 64 from the melon 60. Cut lines generally 72 are formed by the cutting edges 20 of the cutting blades 14, 16 when the cutting tool 10 is moved through the melon 60. The cutlines 72 formed by the cutting tool 10 release the sections 70. The melon 60 has opposing end edges 74, 76.

With reference to FIG. 5, the melon 60 is cut into portions, typically in half. The melon portion 60 is placed in the stand 62 for supporting the melon 60 during the cutting process. The user then places the cutting tool 10 at a first edge 74 with the guide member 24 on or in a boundary zone generally 78 defined by an interior surface 80 of the rind 66 and the edible portion 64 of the melon 60. FIG. 5 depicts the cutting tool 10 in sequential positions 68a-68i during the cutting process for cutting sections 70 of the edible portion 64 of the melon 60. The guide member 24 bears against the interior surface 80 of the rind 66 (see depiction 68a). The user then moves the tool 10 downwardly and angularly into the edible portion 64 of the melon 60 as depicted at 68b-68d. The guide member 24 guidingly bears on the rind surface 80 and rotates while the tool 10 moves through the melon from the first edge 74 to the opposing edge 76 of the melon 60.

During the travel as depicted in FIG. 5, the cutting blades 14, 16 create the cut lines 72 as illustrated in FIG. 6. The cutting plate 22 also slices through the edible portion 64 within the boundary zone 78. When the cutting tool 10 reaches the second edge 76 of the melon 60, the cut section 70 can readily be removed from the melon 60.

It is to be appreciated that alternative cutting processes can be gainfully practiced. For example, with reference to FIG. 5, the cutting tool 10 can be operated as noted above with the user moving the tool from depiction 68a and ending at a first cut at depiction 68d. The user then backs the tool through the cut that was made, and makes an opposite cut starting at depiction 68i and ending at the first cut at 68e. The user thus will be cutting downward into and lateral of the melon rather than cutting upward.

FIG. 6 illustrates in top plan view an exemplary cutting pattern for cutting edible portions 64 from the melon 60. It is to be appreciated that other cutting patterns may be gainfully practiced, and the illustrated example is not limiting. With this cutting pattern, the user first separates a longitudinal portion 70a. This is accomplished by the user positioning the cutting tool 10 at a first end 84. The user moves the cutting tool 10 downwardly and longitudinally, such as at an oblique angle, into the edible portion 64, as illustrated in FIG. 5 in the depiction 68a-68d.

The user then moves the cutting tool 10 longitudinally to the opposing end 86 as depicted at 68e in FIG. 5. The guide member 24 guides the movement of the tool 10 towards the opposing end 86 of the melon 60 by traveling on the surface 80 of the rind 66 in the boundary zone 78. The gap 36 between the knife blades 14, 16 allow the edible portion 64 of the melon in the section being cut to pass as the tool moves. Upon reaching the opposing end 86, the user arcuately moves the tool 10 upwardly along the surface 80 of the rind 66 and then from the melon 60 as shown in depictions 68f-68i.

As illustrated in FIG. 5, the orientation of the tool 10 can initially be angled towards the second end 86 (see depiction 68a). During the travel of the tool 10, the blades 14, 16 form the cutlines 72a, 72b in the edible portion and thereby defining the removable section 70a. At the second end 86, the cutting tool 10 is oriented at an oblique angle towards the first edge 84. The cutting plate 22 cuts the section 70a from the rind 66. The cut edible portion 70a can be removed, or left while the remainder of the melon is cut.

With continuing reference to the example illustrated in FIG. 6, the remainder of the melon 60 is cut. This is accomplished by the user positioning the cutting tool 10 at selected side edge portion 88 of the melon 60. The tool 10 is positioned facing substantially perpendicular to the initial longitudinal cuts 72a, 72b. The user again moves the cutting tool 10 downwardly with the guide member 24 traveling in the boundary zone 78 on the rind surface 80. The user then moves the cutting tool 10 towards the opposing side of the melon 60. The cutting blades 14, 16 define the spaced-apart cutlines 72c, 72d. When the cutting tool 10 reaches the cutline 72a formed by the initial longitudinal cut, the cutting tool 10 can be moved back reversingly and out of the melon. The releases the section 70b. Alternatively, the user can move the tool 10 to the opposing edge to release a section 70 on the opposing side of the melon.

A subsequent section 70 can be released by positioning the tool 10 at an adjacent edge position 92. The cutting blade 14 is in-line with the cutline 72d previously made. The cutting tool 10 then is moved towards the opposing side of the melon to separate a subsequent section. The cutting blade 14 travels along the cut line 72d of the previous cutting step while the opposing cutting blade 16 forms a new cut line 72e. This process is repeated until the entire melon 60 is cut and the sections 70 of the edible portions are released and removed. Wedge portions 94 in the rounded ends of the melon can be releasably cut after removal of the sections 70.

The apparatus and methods disclosed herein can be made and executed without undue experimentation in light of the present disclosure. While the apparatus of this invention have been described in terms of preferred embodiments, it will be apparent to those of skill in the art that variations may be applied to the apparatus and in the method steps or in the sequence of steps thereof described herein without departing from the concept, spirit and scope of the invention. All such similar substitutes and modifications apparent to those skilled in the art are deemed to be within the spirit, scope and concept of the invention as defined by the appended claims.

What is claimed is:

1. A tool to cut edible portions of a melon, comprising:
a handle;
a pair of blades disposed in spaced-apart parallel relation to define a gap therebetween and attached at respective first ends to the handle, each of the blades having at least a first cutting edge in opposing relation;
a cutting plate connected between opposing second ends of the pair of blades;
at least one guide member rotatably attached to the cutting plate, the guide member rotating in response to guidingly bearing on a rind surface of the melon while the tool is moved from a first side edge of the melon to an opposing second side edge, the blades cutting edible portions of the melon and the cutting plate cutting the portion from the rind.

2. The tool as recited in claim 1, comprising a pair of the guide members, each guide member is a disk attached to a stem extending from the cutting plate.

3. The tool as recited in claim 2, wherein the stem comprises an L-shaped member having a first portion that extends from the cutting plate in first direction away from the handle and a second portion that extends laterally towards the opposing stem.

4. The tool as recited in claim 1, wherein the guide member is a roller; and further comprising a pair of side supports extending in opposing relation from the cutting plate and an axle connected therebetween, the roller defining a through bore for being received on the axle.

5. The tool as recited in claim 4, wherein the roller defines an arcuate surface radially from an axle bore.

6. The tool as recited in claim 1, further comprising a lug extending from the cutting plate and a transverse axle attached to the lug, and comprising a pair of the guide members, each received on opposing portions of the lug.

7. The tool as recited in claim 6, wherein each guide member comprises a roller having an axle bore for receiving the portion of the axle.

8. The tool as recited in claim 7, wherein each roller defines an arcuate surface radially spaced from the axle bore of the roller.

9. The tool as recited in claim 1, wherein each blade has a second cutting edge opposing the first cutting edge.

10. The tool as recited in claim 1, wherein the handle defines a plurality of alternating grooves and ridges, for comfortably receiving fingers of a user's hand gripping the handle for use of the tool.

11. The tool as recited in claim 1, wherein the handle comprises opposing shells that connect together.

12. The tool as recited in claim 1, wherein the blades and the cutting plate are unitary.

13. The tool as recited in claim 1, wherein the blades and the cutting plate are molded of a plastic.

14. The tool as recited in claim 1, wherein the blades and the cutting plate are metal and connected rigidly together.

15. A method of cutting edible portions of a melon, comprising the steps of:
(a) positioning a guide member of a cutting tool on a boundary of the melon between a rind and an edible portion of the melon, the guide member rotatably attached to a cutting plate connected between end portions of a pair of spaced-apart blades attached at opposing ends to a handle, the blades defining a gap therebetween, each of the blades having at least a first cutting edge;
(b) moving the tool at an oblique angle in first direction to drive the guide member along the boundary and the blades into and through the edible portion of the melon to a second opposing side of the melon, the cutting plate separating the edible portion along the boundary with the rind; and
(c) moving the tool in a second direction with the guide member rotating along the boundary to remove the tool from within the melon outwardly thereof and leaving a readily removable severed edible portion of the melon.

16. The method as recited in claim 15, comprising the step of repeating steps (a)-(c) to remove other edible portions of the melon.
